(19) United States
(12) Patent Application Publication
(10) Pub. No.: US 2009/0270036 A1
(43) Pub. Date: Oct. 29, 2009

(54) Wireless Pairing Ceremony

(75) Inventor: Alain L. Michaud, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/412,602

(22) Filed: Mar. 27, 2009

Related U.S. Application Data
(63) Continuation-in-part of application No. 12/111,218, filed on Apr. 29, 2008.

(51) Int. Cl. H04B 7/00

(52) U.S. Cl. 455/41.3

(57) ABSTRACT

A host wireless device may use an evaluation process to determine whether a secured connection is available for a given guest device during initiation of a pairing ceremony. If the guest device does not support a secured connection, no passcode is used. Selection of a default password, auto-generated password, or manually entered password are based on the display and input capabilities of the guest device. An identifier saving the correct pairing ceremony is used so that the same pairing ceremony can be automatically used when the host subsequently connects to a repeat guest.

This is a continuation-in-part of U.S. application Ser. No. 12/111,218, filed Apr. 29, 2008, the entire disclosure of which is incorporated herein by reference.

### BACKGROUND

Even though a known protocol may define requirement for a connection between two devices, more than one setting may be available when configuring the connection. For example, security settings and device capability may vary from device to device and may affect settings for both an initiating device and a responsive device.

For example, a Bluetooth host, such as a cellular telephone, may connect to a laptop computer to download pictures or may connect to a hands-free headset for use in a call. The capabilities of the laptop computer and the headset are much different, particularly in a user's ability to interact with them. A laptop has both a keyboard and display, while the headset may have only a rudimentary display or input capability, if any.

### SUMMARY

A method of selecting a pairing ceremony for wireless connections, such as Bluetooth piconet, selects a pairing ceremony for a connection based on the capabilities of the guest device. If the Bluetooth guest device does not support authentication, a default connection may be used. When a Bluetooth guest device supports authentication, a default value or a generated value may be used. Should the default or generated value fail, a user may be prompted to input a passcode. When this occurs, the passcode may be stored for subsequent use with the same device. A catalog of known Bluetooth guest devices may be maintained using an identifier, such as a media access control address (MAC address).

### BRIEF DESCRIPTION OF THE DRAWINGS

FIG. 1 is a block diagram of a computer providing a suitable platform for hosting a wireless pairing ceremony;

FIG. 2 is a block diagram of a wireless host device and representative wireless guest devices; and

FIG. 3 is a method of selecting a pairing ceremony for connection of wireless devices.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

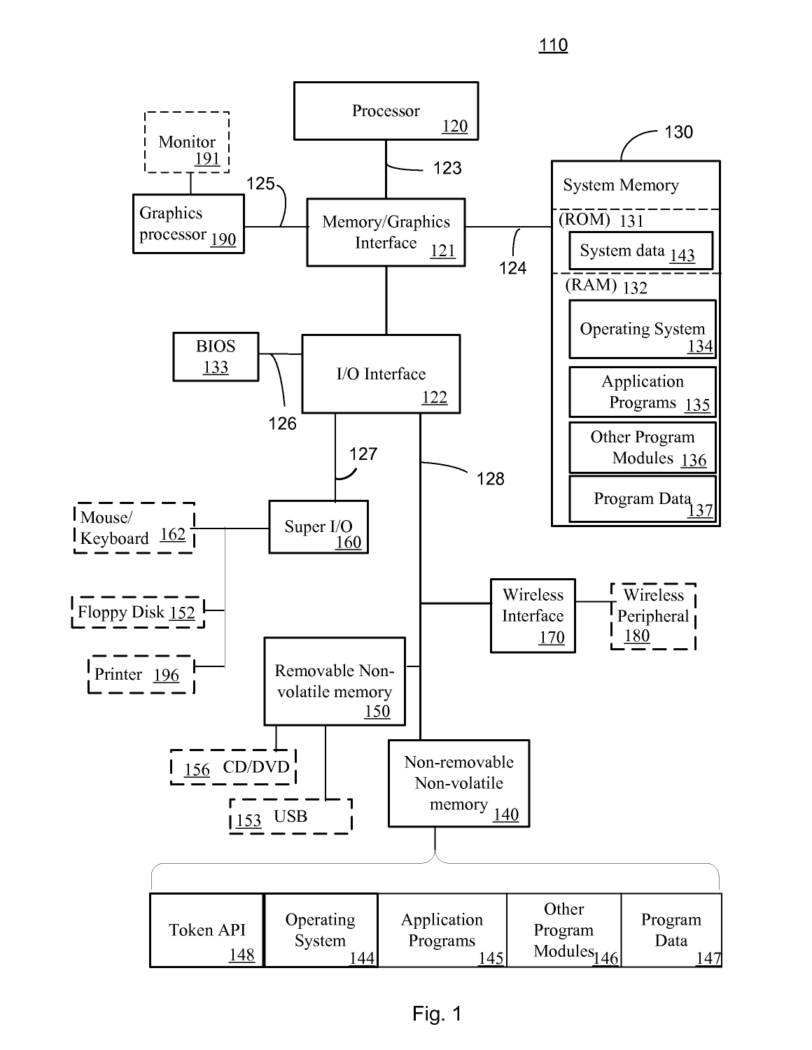

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this architectural pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 153 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may support connections to one or more wireless peripheral devices, such as a wireless device 180 via a wireless interface controller 170. The wireless device 180 may be another computer, a cellular telephone, a handsfree headset, a keyboard, a mouse, printer, etc. The logical connection between the wireless interface controller 170 and the wireless device 180 depicted in FIG. 1 may include an infrared wireless connection, Bluetooth wireless connection, or similar connection. Such short-range wireless networking environments are in common use for personal electronics, offices, and elsewhere.

In some embodiments, the network interface may use a modem (not depicted) when a broadband connection is not available or is not used. It will be appreciated that the network connection shown is exemplary and other means of establishing a communications link between the computers may be used.

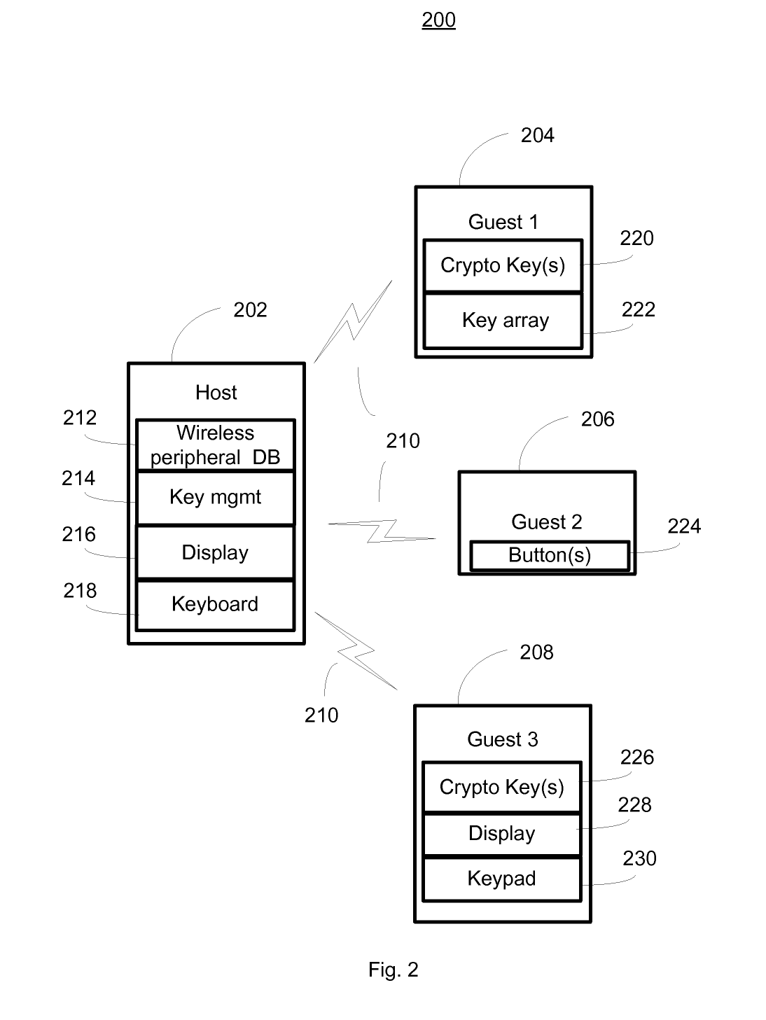

FIG. 2 is block diagram 200 of a wireless device 202 and a plurality of wireless guest devices 204, 206, 208.

For the sake of illustration, the host device 202 may be a laptop computer, such as computer 110 of FIG. 1. The host device 202 may be in range of a number of peripheral devices. For example, a first guest device 204 may be a wireless keyboard, a second guest device 206 may be a wireless mouse, and a third guest device 208 may be a cellular telephone with short range wireless network support, such as Bluetooth or other WLAN or piconet.

The host 202 and guest devices 204, 206, and 208 may be connected over a wireless link 210.

The host device 202 may include a wireless pairing database 212 that stores information about known guest devices, previously encountered guest devices, or both. The wireless pairing database 212. The wireless pairing database 212 may be separate database, flat file, etc. In some embodiments the wireless pairing database 212 may be stored in a system file, such as the registry in a Windows® operating system environment. To facilitate guest device pairing, a number of common devices may be pre-populated in the wireless pairing database 212.

The host device 202 may also include a key management module 214, for, among other uses, generating passcodes, symmetric keys, and public key pairs. The host device 202 may also include a display 216, and a keyboard 218.

However, in some environments, for example, in an office setting, it may be useful to have an additional, separate keyboard and mouse. The first and second guest devices 204 and 206 may be wirelessly connected to fill this need.

The first guest device 204, e.g. a keyboard, may include a key store 220 for use in encrypting key data transmission, and may also, include a key array 222 to support typing and data entry. The second guest device 206 (mouse) may not have a key store, because there is little risk associated with cursor movement so encryption may not be necessary. The second guest device 206 may not have a display, but is likely to have at least a button input 230. The third guest device 208 (cellular telephone) may have a key store 226, a display 228, and a keypad 230.

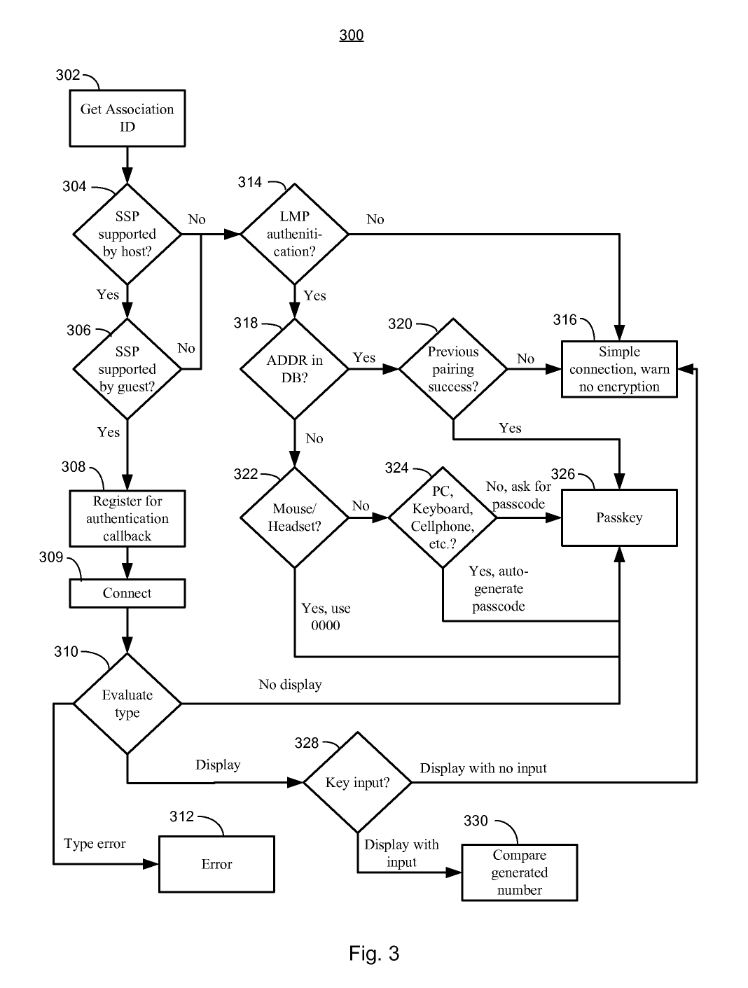

In operation, the host device 202 may discover each of the potential guest devices 204, 206, and 208. Selection of a pairing ceremony for each may begin. If a device supports secure simple pairing (SSP) as defined in the Bluetooth 2.1 standard, then a first general selection criteria may be used, and will be discussed further below. If either the host or the guest does not support SSP, then a second general selection criteria may be followed. Using either path, one of three outcomes may be reached. The first outcome is a simple connection without encryption. The second outcome is a confirmation of a displayed numeric value used as the basis for encryption. The third outcome is the use of a default or generated passkey as the basis for encryption. The full pairing ceremony selection is discussed in more detail with respect to FIG. 3.

FIG. 3 illustrates a method of selecting a pairing ceremony for wireless devices. At block 302, a host device 202 may get an association identifier for a guest device, such as one of the guest devices 204, 206, 208 of FIG. 2.

At block 304, a determination may be made as to whether the host device 202 supports secure simple pairing (SSP), indicative of Bluetooth 2.1. If true, the ‘yes’ branch may be followed to block 306.

At block 306, a determination may be made as to whether the guest device supports SSP. If true, the ‘yes’ branch may be taken to block 308. At block 308, since both the host and guest devices support SSP, the host may register for authentication callback and then, at block 309, connect to the guest and wait.

At block 310, if the guest device has no display, the “No display” branch may be taken to block 326. A passkey for the guest device, such as the second guest device 206, in this example, a mouse, may be input by a user at the host device 202.

At block 310, if the guest device has a display, the “Display” branch from block 310 may be taken to block 328. If, at block 328, the guest device has a display and some ability to input at least a yes or no, that is, at least one or two buttons, the “Display with input” branch may be taken to block 330.

At block 330, a human readable numeric value may be generated and sent to the guest device (not depicted). A user can read the displayed value and compare it to a value on the display 216 of the host device 202. Based on the comparison, the user can enter a confirmation or rejection that the numbers match using the guest device input capability. If confirmed, the numeric value can be used as the basis for some level of secured communication.

Returning to block 328, if the device has a display with no ability to input even a yes/no value, the “Display with no input” branch may be taken from block 328 to block 316. At block 316, a default link may be established. A warning may be posted that no encryption will be used.

Returning to blocks 304 and 306, if either device is not capable of an SSP connection, their respective “no” branches may be taken to block 314.

At block 314, a determination may be made if both the host and guest devices support a link management protocol (LMP), indicative of Bluetooth 2.0. If either or both devices do not support LMP, the “no” branch from block 314 may be taken to block 316, where the user may be alerted that no encryption will be used in communication between the two devices and a simple connection may be established.

If, at block 314, both the host and guest devices do support LMP, the “yes” branch from block 314 may be taken to block 318. At block 318, the host device, e.g. host device 202, may use the media access control address (MAC address) of the guest device and look in its wireless pairing database 212 to determine if this guest device has been encountered before. If so, the “yes” branch from block 318 may be taken to block 320.

At block 320, if the wireless pairing database 212 indicates previous success at pairing with the guest device, the “yes” branch may be taken and a previously stored PIN or passkey is used to establish an encrypted session between the host device and the guest device.

At block 320, if the wireless pairing database 212 indicates that a previous pairing did not result in a usable PIN or passcode, the “no” branch may be taken to block 316, and a simple connection established. The user may be warned that no encryption is in use.

Returning to block 318, if the guest device is not in the wireless pairing database 212, the “no” branch from block 318 may be taken to block 322. At block 322, if the device is a mouse or headset, the “yes” branch may be taken and a standard default passcode value of 0000 may be used. If at block 322, the guest device is not a mouse, headset, or other device that uses a default passcode, the “no” branch may be taken to block 324.

At block 324, if the guest device has a full character input capability, for example, a keyboard, a personal computer, a cellular telephone, etc., the “yes” branch from block 324 may be taken to block 326 using an auto-generated passcode value. If, at block 324, the answer is no, the “No” branch may be taken to block 326 and the user may be asked to input a manufacturers PIN or passcode. In some embodiments, the passcode may be used to generate session keys for the connection.

At block 326, the PIN or passcode resulting from whatever entry point may be used to create an encrypted session between the host device and the guest device. If the guest device has not been previously recorded in the wireless pairing database, a device identifier may be added after successful pairing, for use in a subsequent pairing ceremony.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of pairing ceremony selection for establishing a connection between a host electronic device and a guest device, the method comprising:
downloading guest device information;
determining if the guest device has been previously paired with the host electronic device;
determining a type for the guest device;
connecting the host electronic device to the guest device using a prior pairing ceremony when the guest device has been previously paired;
activating a default link to the guest device when a pairing ceremony is not supported;
setting a link passcode to a default value after determining the guest device is a first type;
setting the link passcode to an auto-generated value after determining the guest device is a second type;
saving a device identifier associated with the guest device if not previously saved; and
associating a current pairing ceremony with the device identifier.

2. The method of claim 1, wherein determining if the guest device has been previously paired with the host electronic device comprises checking a media access control address (MAC address) of the guest device against MAC addresses of previously paired guest electronic devices.

3. The method of claim 1, wherein the default value is 0000.

4. The method of claim 1, wherein the first type is a keyboard-less device type.

5. The method of claim 1, wherein the second type has at least one of a keyboard and a display.

6. The method of claim 1, wherein the host electronic device and the guest electronic device each support communication over a Bluetooth 2.0 wireless connection.

7. A computer having a computer-readable storage medium with computer-executable instructions that implement a method of selecting a pairing ceremony with a guest device, the method comprising:
receiving an identifier from the guest device;
determining if the guest device supports secure simple pairing (SSP);
when the guest device does not support SSP, determining when the guest device supports a link management protocol;
when the guest device supports link management protocol, checking whether the guest device has been entered in a wireless pairing database;
when the guest device has been entered in the wireless pairing database, selecting a previously used pairing ceremony for the guest device; and
establishing a connection with the guest device using the selected pairing ceremony.

8. The computer of claim 7, wherein the method implemented by the computer-executable instructions further comprises:
when the guest device supports SSP, determining whether the guest device has a display and an input capability; and
generating a numeric comparison value for use in pairing when the guest device has a display and input capability.

9. The computer of claim 7, wherein the method implemented by the computer-executable instructions further comprises:
when the guest device supports link management protocol and has not been entered in the wireless pairing database, determining a type of guest device;
when the type of guest device has a key input but no display, using a passcode of 0000 for pairing.

10. The computer of claim 7, wherein the method implemented by the computer-executable instructions further comprises:
when the guest device supports link management protocol and has not been entered in the wireless pairing database, determining a type of guest device;
when the type of guest device has a key input but no display, setting a passcode of 0000 for pairing.

11. The computer of claim 7, wherein the method implemented by the computer-executable instructions further comprises:
when the guest device supports link management protocol and has not been entered in the wireless pairing database, determining a type of guest device;
when the type of guest device has a full input keyboard, generating a passcode.

12. The computer of claim 7, wherein the method implemented by the computer-executable instructions further comprises:
when the guest device does not support link management protocol, establishing a link without encryption.

13. A method of selecting a pairing ceremony with a guest device comprising:
receiving an identifier from the guest device;
determining if the guest device supports secure simple pairing (SSP);
when the guest device supports SSP, determining whether the guest device has a display and an input capability and generating a numeric comparison value for use in pairing when the guest device has a display and input capability.
when the guest device does not support SSP and the guest device supports link management protocol, using a previous pairing ceremony associated with the guest device when a guest device information is available in a wireless pairing database;
when the guest device does not support SSP and supports link management protocol, using a 0000 passcode for the pairing ceremony when the guest device has a key input but no display.

14. The method of claim 13, further comprising:
when the guest device supports link management protocol and has not been entered in the wireless pairing database, determining a type of device;
when the type of device has a full input keyboard, generating a passcode for use in the pairing ceremony.
